(19) United States
(12) Patent Application Publication
(10) Pub. No.: US 2006/0005026 A1
(43) Pub. Date: Jan. 5, 2006

(54) Method and apparatus for secure communication reusing session key between client and server

(75) Inventors: Kwan-woo Song, Seoul (KR); Seung-woo Lee, Seoul (KR); Hee-dong Kim, Busan (KR); Jai-young Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/147,286

(22) Filed: Jun. 8, 2005

(30) Foreign Application Priority Data
Jun. 9, 2004 (KR) 10-2004-0042275

(51) Int. Cl. H04L 9/00

(52) U.S. Cl. 713/173

(57) ABSTRACT

A method and apparatus for secure communication between a client and a server are provided. In the method, in order to enable communication between the client and the server, a session key is managed according to session identification information corresponding to the session key, and if there is a valid session key, data is encrypted or decrypted using the session key. If there is no valid session key, the client generates a new session key, operations for enabling application programs executed on one client to share a single session key are performed, so that secure communication is performed using the session key.

### CROSS-REFERENCE TO RELATED APPLICATIONS

This application claims priority from Korean Patent Application No. 10-2004-0042275 filed on Jun. 9, 2004 in the Korean Intellectual Property Office, the disclosure of which is incorporated herein by reference in its entirety.

### BACKGROUND OF THE INVENTION

1. Field of the Invention

The present invention relates to a method and apparatus for secure communication using a session key between a client and a server, and more particularly, to a method and apparatus for secure communication reusing a session key, by which a generated session key is not discarded even after a session ends but is managed according to session identification information and is reused in communication between a client and a server which share the session key under predetermined conditions, thereby reducing a load due to a procedure for sharing the session key, and by which an additional application program generated in the client is allowed to use the session key, thereby facilitating the management of the session key.

2. Description of the Related Art

With the use of the World Wide Web (WWW) as the major means of information communication and the commercial spread of the WWW, the necessity of protecting sensitive information such as purchase, order, or payment information transferred on the WWW is increasing day by day. However, a Transmission Control Protocol/Internet Protocol (TCP/IP) network is very weak in security due to protocol characteristics. Accordingly, for security, it is needed to encrypt the sensitive information (e.g., a credit card number and a password) transferred on the WWW (especially, on an electronic commerce site) under an agreement between two parties in communication.

Representative encryption methods are symmetric-key cryptography and public-key cryptography.

Symmetric-key cryptography is called secret-key cryptography in which a key used to encrypt data is the same as that used to decrypt the data. A data encryption standard (DES) is most usually used for symmetric-key cryptography. Recently, applications using an advanced encryption standard (AES) are increasing.

Public-key cryptography is called asymmetric encryption in which a key used to encrypt data is different from that used to decrypt the data. A pair of the keys are generated to be dependent on each other using a predetermined algorithm. A key used for encryption is referred to as a public key and a key used to decrypt text encrypted using the public key is referred to a private key. The private key is kept secret by a user while the public key is published and can be widely distributed. Text encrypted by the public key can only be decrypted by the paired private key. Examples of a public-key cryptosystem are a Diffie-Hellman cryptosystem, an RSA cryptosystem, an ElGamal cryptosystem, and an elliptic curve cryptosystem. Public-key cryptography is about 100-1000 times slower than symmetric-key cryptography and is thus used for key exchange or a digital signature instead of being used for encryption of content.

In practical applications of information encryption, a hybrid encryption system combining symmetric-key cryptography and public-key cryptography is used. In a hybrid encryption system, anyone can encrypt a message, but only people having a private key can decrypt the message. Actually, a message to be transmitted is encrypted using a randomly generated session key according to symmetric-key cryptography.

FIG. 1 illustrates a procedure for sharing a session in a conventional secure socket layer (SSL) complying with hybrid encryption. An SSL protocol provides secure communication between a client and a server using authentication, a digital signature for integrity, encryption for privacy, etc. on a protocol layer located between a network layer (e.g., TCP/IP) and an application layer. The SSL protocol was suggested by Netscape and has been substantially recognized as the standard of a security solution on a web.

In the conventional SSL, the session sharing procedure complies with hybrid encryption. When a user accesses a web server using a web browser, the web server provides a certificate including the web server's public key. The web browser, i.e., a client, acquires the web server's public key from the certificate, generates a session key (S10), encrypts the session key using the web server's public key (S20), and transmits the encrypted session key to the web server. The web server decrypts a received message using its private key to acquire the session key (S30), encrypts a message using the session key (S40), and transmits the encrypted message to the client. The client decrypts the message from the web server using the session key (S50). When communication between the client and the web server ends, the client sends a session finish request to the web server and the client and the web server discard the session key (S60). A session key is discarded when a session ends and a new session key is generated whenever a new session is generated in order to prevent security problems that may be caused by an information leak.

In the conventional SSL protocol, however, the session key sharing procedure that must be always performed when a client accesses a server incurs a load on a central processing unit (CPU). As a result, the availability of the server is decreased and a transmission rate between the server and the client is also decreased. Since a session key sharing operation incurs the biggest load in data security, the conventional SSL protocol is not practical in a network environment, e.g., a home network environment, in which there are frequent access and many transactions. Moreover, since every web browser executed on one personal computer (PC) must independently perform the session key sharing operation with a server, the conventional SSL protocol cannot be used in a network environment in which messages broadcast from the server need to be processed.

### SUMMARY OF THE INVENTION

An aspect of the present invention provides a method and apparatus for secure communication reusing a session key between a client and a server, by which a session key shared by the client and the server is managed according to session identification information and reused even after a session between the client and the server ends, thereby reducing a load in a session key sharing procedure, and by which an additional application program generated in the client securely communicates with the server without an additional session key sharing procedure, thereby reducing a load in session key management.

The above stated aspect as well as other aspects, features and advantages, of the present invention will become clear to those skilled in the art upon review of the following description, the attached drawings and appended claims.

According to an aspect of the present invention, there is provided a method for secure communication between a client and a server, including transmitting a certificate to at least one accessing client, receiving a session key generated by the client, generating session identification information corresponding to the session key, transmitting the session identification information to the client, and decrypting an encrypted message received from the client using the session key and encrypting a message to be transmitted to the client using the session key.

According to another aspect of the present invention, there is provided a method for secure communication between a client and a server, the method including transmitting a certificate to at least one accessing client, receiving a session key and session identification information, which are generated and encrypted using a public key included in the certificate by the client, decrypting the encrypted session key and session identification information, and decrypting an encrypted message received from the client, which has transmitted the session identification information, using the session key and encrypting a message to be transmitted to the client, which has transmitted the session identification information, using the session key.

According to still another aspect of the present invention, there is provided a method for secure communication between a client and a server, the method including accessing at least one server, receiving a certificate from the server, extracting a public key of the server from the certificate, generating a session key for communication with the server, encrypting the session key using the public key and transmitting the encrypted session key to the server, receiving session identification information corresponding to the session key from the server, and decrypting an encrypted message received from the server, which has generated the session identification information, using the session key and encrypting a message to be transmitted to the server, which has generated the session identification information, using the session key.

According to yet another aspect of the present invention, there is provided a method for secure communication between a client and a server, the method including accessing at least one server, receiving a certificate from the server, extracting a public key of the server from the certificate, generating a session key and session identification information corresponding to the session key for communication with the server, encrypting the session key and the session identification information using the public key and transmitting the encrypted session key and session identification information to the server, and decrypting an encrypted message received from the server, which has been accessed and is identified by the session identification information, using the session key and encrypting a message to be transmitted to the server, which has been accessed and is identified by the session identification information, using the session key.

According to a further aspect of the present invention, there is provided an apparatus for secure communication, including a session identification information generation module generating session identification information, and a transceiver module transmitting a certificate to an accessing client, receiving a session key from the client, transmitting the session identification information generated by the session identification information generation module to the client, and transmitting and receiving a message encrypted using the session key.

According to a still another aspect of the present invention, there is provided an apparatus for secure communication, including a session identification information generation module generating session identification information; a transceiver module transmitting a certificate to an accessing client, receiving a session key from the client, transmitting the session identification information generated by the session identification information generation module to the client, and transmitting and receiving a message encrypted using the session key; and an encryption module encrypting a message to be transmitted to the client using the session key received by the transceiver module and decrypting an encrypted message received by the transceiver module using the session key.

According to still another aspect of the present invention, there is provided an apparatus for secure communication, including a session key generation module generating a session key, a transceiver module receiving a certificate from a server, transmitting the session key generated by the session key generation module to the server, receiving session identification information corresponding to the session key from the server, and transmitting and receiving a message encrypted using the session key, a control module extracting a public key from the certificate received by the transceiver module, and an encryption module encrypting the session key generated by the session key generation module using the public key extracted by the control module, and encrypting and decrypting a message using the session key.

According to still another aspect of the present invention, there is provided an apparatus for secure communication, including a session key generation module generating a session key, a session identification information generation module generating session identification information corresponding to the session key, a transceiver module receiving a certificate from a server and transmitting the session key generated by the session key generation module and the session identification information generated by the session identification information generation module to the server, a control module extracting a public key from the certificate received by the transceiver module, and an encryption module encrypting the session key generated by the session key generation module and the session identification information generated by the session identification information generation module using the public key extracted by the control module, and encrypting and decrypting a message using the session key.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a procedure for sharing a session in a conventional secure socket layer (SSL);

FIG. 2 is a diagram of a system according to an exemplary embodiment of the present invention;

FIG. 3 is a diagram of a client according to an exemplary embodiment of the present invention;

FIG. 4 is a diagram of a server according to an exemplary embodiment of the present invention;

FIG. 5 is a flowchart of a method for secure communication according to an exemplary embodiment of the present invention;

FIG. 6A is a flowchart of the operations of a client in an exemplary embodiment of the present invention;

FIG. 6B is a flowchart of the operations of a client in another exemplary embodiment of the present invention;

FIG. 7A is a flowchart of the operations of a server in an exemplary embodiment of the present invention;

FIG. 7B is a flowchart of the operations of a server in another exemplary embodiment of the present invention;

FIG. 8 illustrates an example of session identification information generated by a server according to a method for secure communication according to the present invention;

FIG. 9 illustrates a state in which a plurality of application programs executed on one client share a single session key;

FIG. 10 is a flowchart of operations performed by a client to enable a plurality of application programs executed on the client to share a single session key; and

FIG. 11 is a flowchart of operations performed by a server to enable a plurality of application programs executed on one client to share a single session key.

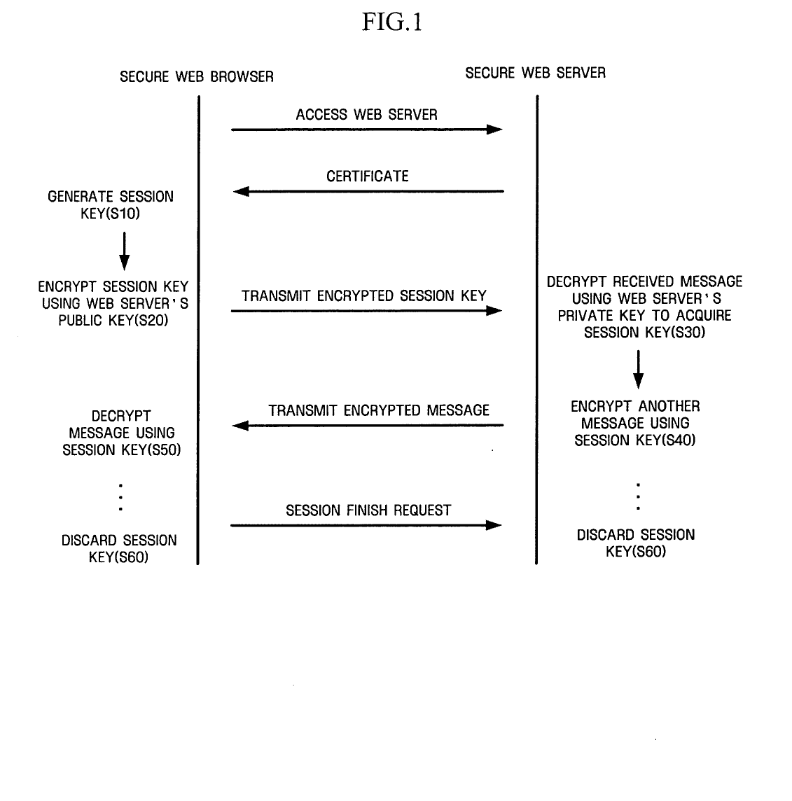

### DETAILED DESCRIPTION OF THE INVENTION

The present invention will now be described more fully with reference to the accompanying drawings, in which exemplary embodiments of the invention are shown.

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

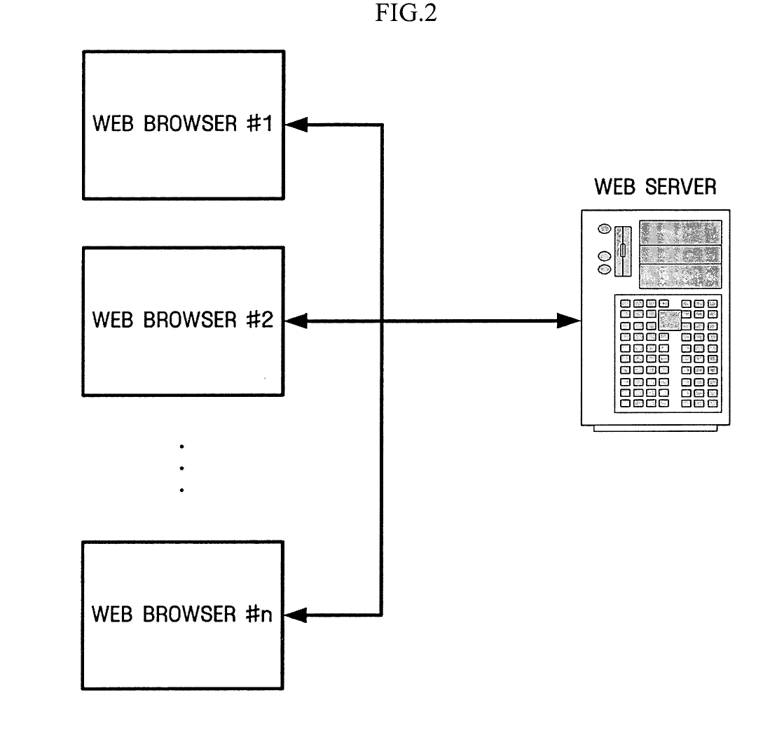

FIG. 2 is a diagram of a system according to an exemplary embodiment of the present invention.

The present invention can be used in a system environment such as a network environment in which there are frequent access and many transactions or a network environment in which messages broadcast by a server need to be processed. An example of such a system environment may be a home network environment in which household appliances, electric systems, and cooling and heating systems at home can be remotely controlled by accessing a server through a client. Referring to FIG. 2, the present invention can be used in a client-server system in which a client where a plurality of application programs (web browsers #1 through #n) are executed is connected with a server providing services to the client through a network. However, it will be obvious to those skilled in the art that the present invention can be used for encrypted communication between a source and a sink under a network environment, in which there are frequent access and many transactions, besides the client-server system.

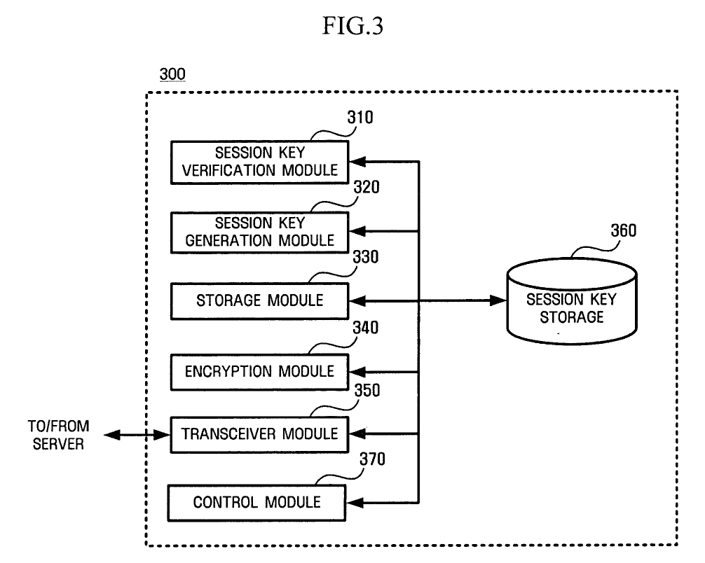

FIG. 3 is a diagram of a client 300 according to an embodiment of the present invention.

The client 300 includes a session key verification module 310, a session key generation module 320, a control module 370, a storage module 330, an encryption module 340, a transceiver module 350, and a session key storage 360.

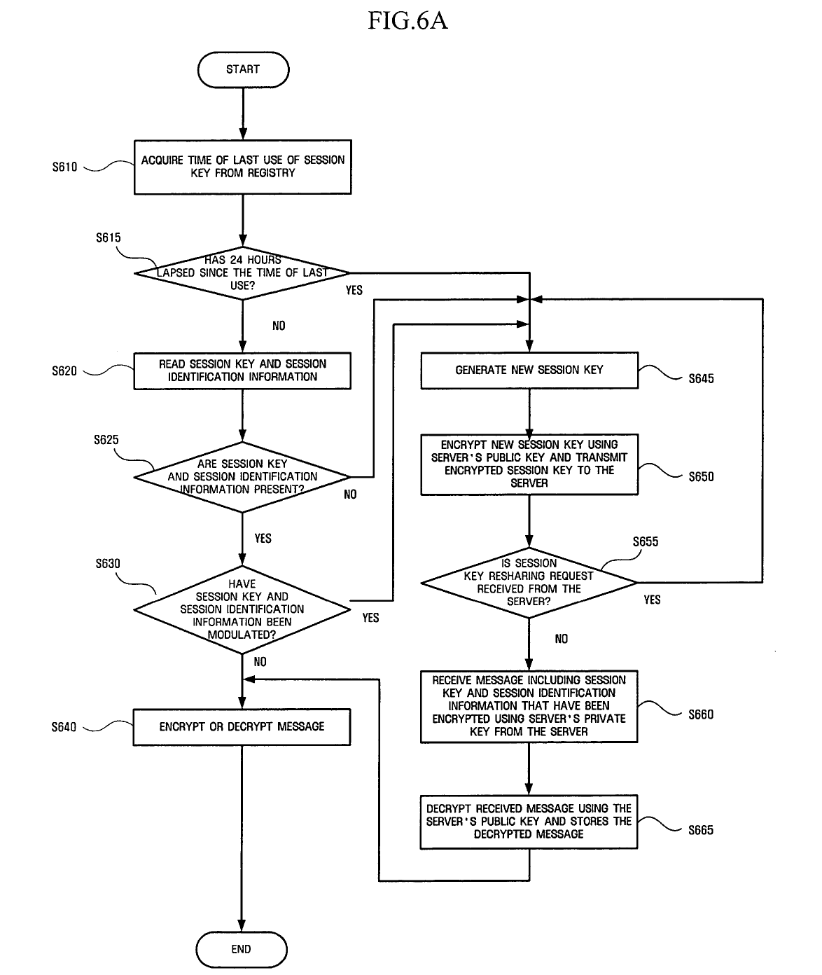

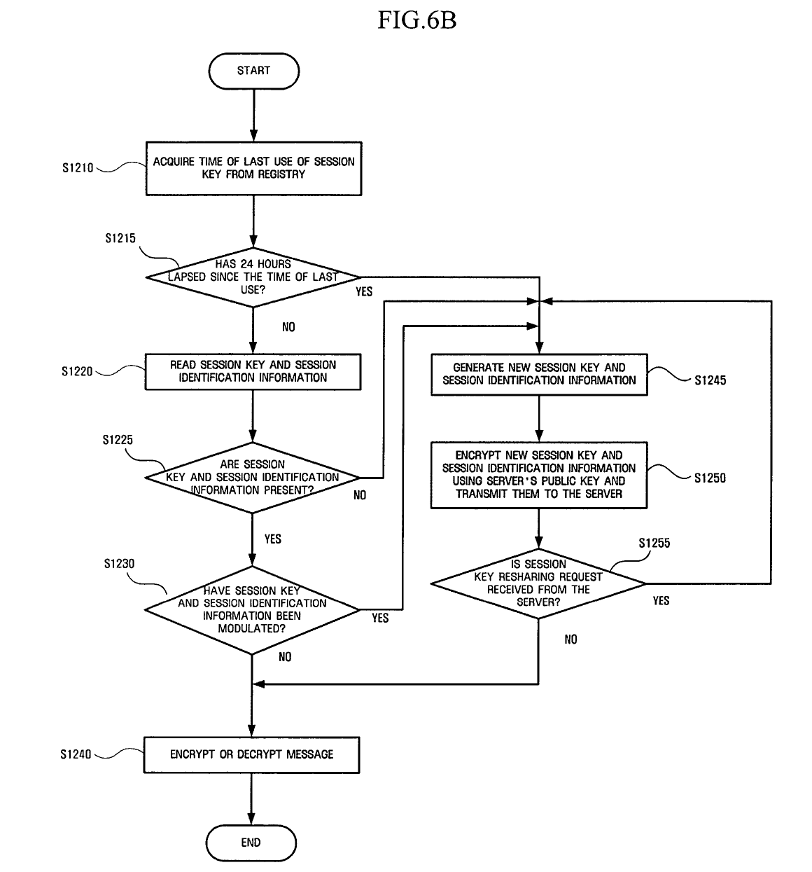

The session key verification module 310 verifies whether a session key stored in the session key storage 360 is reusable. A procedure for verifying whether a session key is reusable and valid will be described in detail with reference to FIG. 6 later. When there is no reusable and valid session key as a result of the verification of the session key verification module 310, the session key generation module 320 generates a new session key. The encryption module 340 encrypts the session key generated by the session key generation module 320 using a server's public key and encrypts or decrypts a message to be transmitted to or received from the server using the session key. The transceiver module 350 transmits to the server the session key encrypted using the server's public key by the encryption module 340 and the message encrypted using the session key by the encryption module 340 and receives session identification information and a message encrypted using the session key from the server. The storage module 330 stores the session key generated by the session key generation module 320 and the session identification information received through the transceiver module 350 in the session key storage 360.

In another embodiment of the present invention, a client may generate session identification information corresponding to a session key. This will be described with reference to FIG. 6B later.

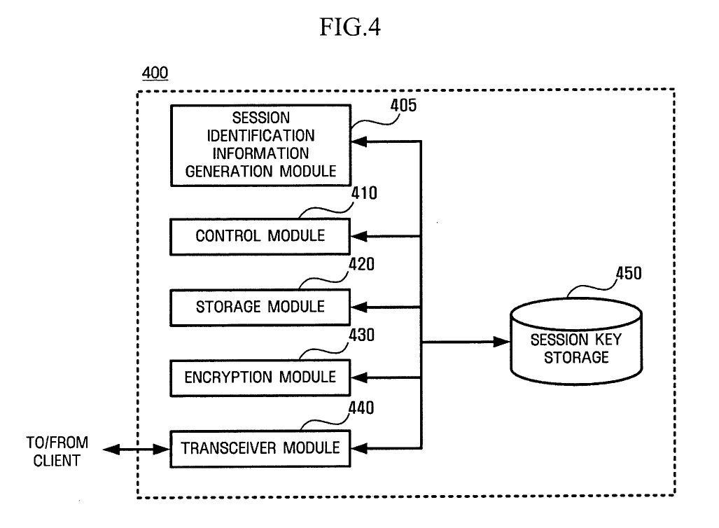

FIG. 4 is a diagram of a server 400 according to an embodiment of the present invention.

The server 400 includes a session identification information generation module 405, a control module 410, a transceiver module 440, an encryption module 430, a storage module 420, and a session key storage 450. The control module 410 generates a message for requesting a client to reshare a session key and manages the operations of other modules.

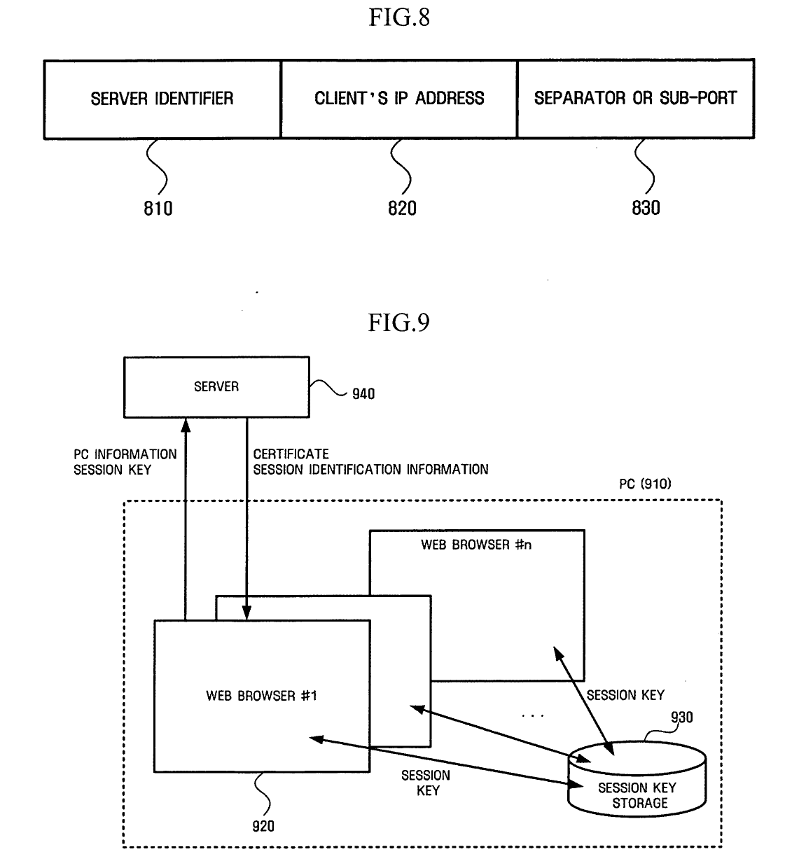

The session identification information generation module 405 generates session identification information corresponding to the session key. The session identification information is an identifier of the session key used to manage the session key and has a format shown in FIG. 8. Since the session identification information is for identifying a session between a client and a server, it fundamentally includes information for identifying the client and information for identifying the server and may optionally include sub-port information of the server.

For example, when there are one client and a plurality of servers, the session identification information may include only information for identifying a server. When there are a plurality of clients and one server, a session can be identified only with the information for identifying a client. When there are a plurality of clients and servers, the session identification information needs to include both of the information for identifying a client and the information for identifying a server in order to identify a session. The information for identifying a client and a server may include any information by which the client and the server can be identified.

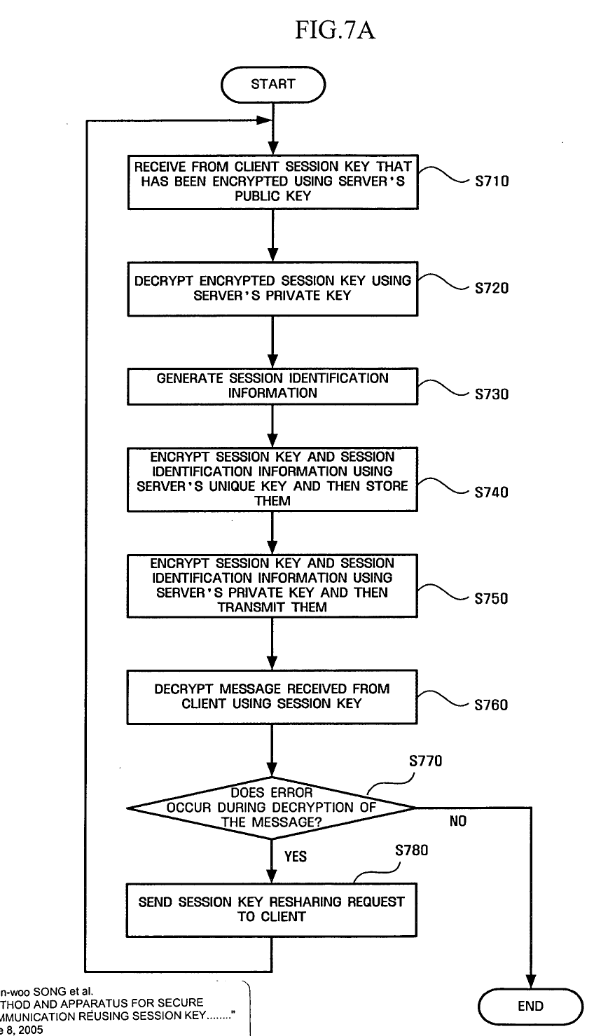

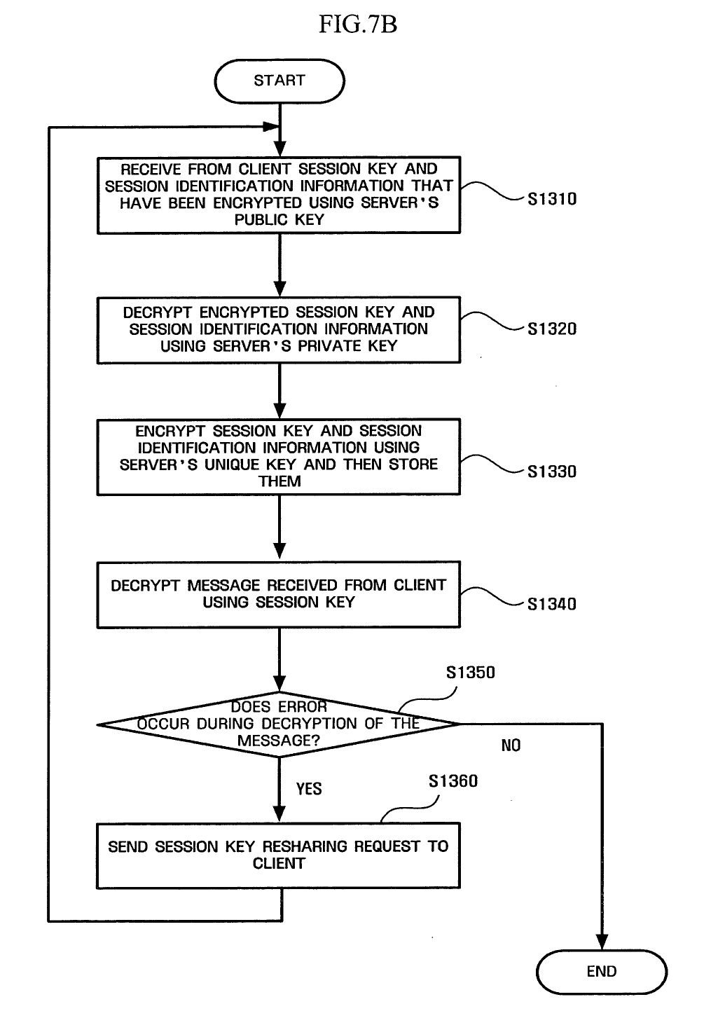

Under a client-server system environment using an embodiment of the present invention, as shown in FIG. 8, the session identification information may include a server identifier 810 as the information for identifying a server, a client's Internet Protocol (IP) address 820 or a client's Media Access Control (MAC) address as the information for identifying a client, and a sub-port 830 of a service provided by the server. Requesting a client to reshare a session key will be described with reference to FIG. 7 later.

The transceiver module 440 receives a session key and data encrypted using the session key from a client and transmits to the client the session identification information generated by the session identification information generation module 405 and a session key resharing request message generated by the control module 410. The encryption module 430 decrypts a received message using the session key provided through the transceiver module 440 and encrypts a message to be transmitted to the client. The storage module 420 stores the session key provided through the transceiver module 440 and the session identification information generated by the session identification information generation module 405 in the session key storage 450.

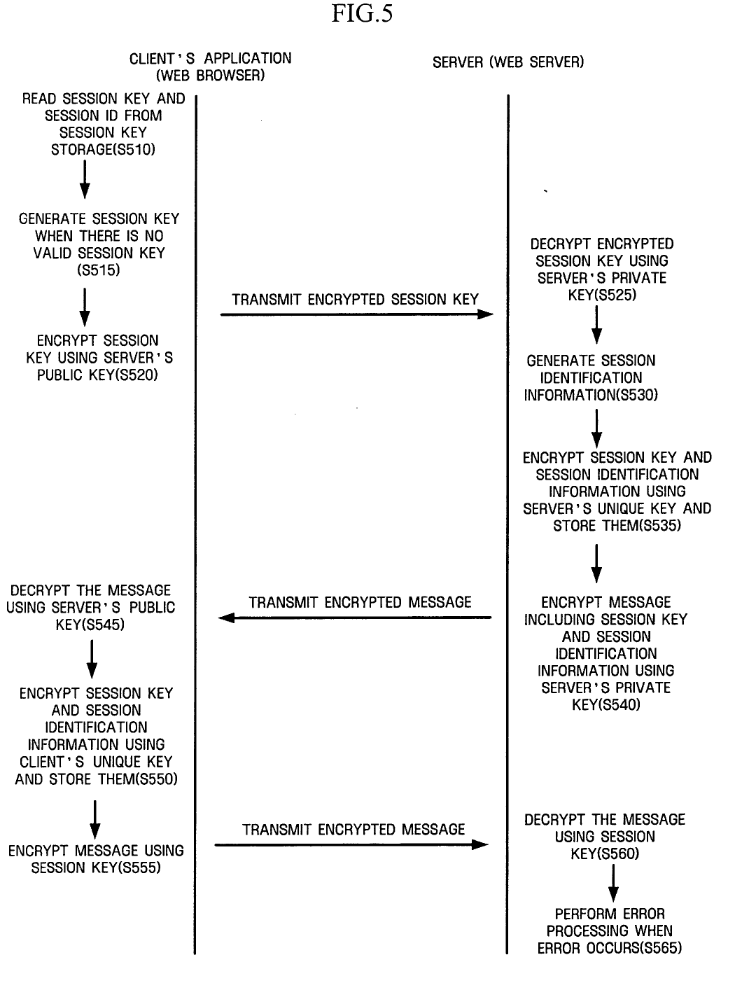

FIG. 5 is a flowchart of a method for secure communication according to an embodiment of the present invention.

In operation S510, an application, e.g., a web browser, generated on a client reads a session key and session identification information, e.g., data containing a session identifier (ID), from the session key storage 360, and then the session key verification module 310 determines whether a reusable and valid session key is present. When it is determined that there is no reusable and valid session key, the session key generation module 320 generates a new session key in operation S515 and the encryption module 340 encrypts the session key using a server's public key in operation S520 and provides the encrypted session key to the transceiver module 350. The transceiver module 350 transmits the encrypted session key to the server.

The server, e.g., a web server, decrypts the encrypted session key received through the transceiver module 440 using its private key in the encryption module 430 in operation S525, generates session identification information for managing the session key in the session identification information generation module 405 in operation S530, encrypts the session key and the session identification information using its unique key, and stores them in the session key storage 450 through the storage module 420 in operation S535. The server encrypts a message including the session key and the session identification information using its private key in the encryption module 430 in operation 540 and transmits the encrypted message to the client through the transceiver module 440.

Then, the client decrypts the encrypted message received through the transceiver module 350 using the server's public key in the encryption module 340 in operation S545, and encrypts the session key and the session identification information included in the decrypted message using its unique key and stores them in the session key storage 360 through the storage module 330 in operation S550. Through the above operations, the client and the server become to share the session key.

When the client has a message to be transmitted to the server, the client encrypts the message using the session key in operation S555 and transmits the encrypted message to the server. Then, the server decrypts the received message using the session key in operation S560. When an error occurs during the decryption, the server performs error processing in operation S565. The error processing will be described in detail with reference to FIG. 7 later.

FIG. 6A is a flowchart of the operations of a client in an embodiment of the present invention.

The client verifies whether a reusable and valid session key is present in operations S610 through S630. In detail, the client acquires a time when the session key is used last from a registry in operation S610. When it is determined that 24 hours has not lapsed since the time of last use in operation S615, the client reads a session key and session identification information from the session key storage 360 through the storage module 330 in operation S620. When it is determined that the session key and the session identification information are present in the session key storage 360 in operation S625, the client determines whether the session key and the session identification information have been modulated in operation S630. When it is determined that the session key and the session identification information have not been modulated, the client encrypts or decrypts a message using the session key during communication.

As mentioned above, one of the factors which determine whether or not a client reuses the stored session key is the amount of time lapsed since the last use of the session key. The amount of time lapsed since the last use of the session key may be determined through experiments considering a system's need for security, a system implementation environment, a supported network environment, etc. Accordingly, 24 hours used as the amount of time lapsed in operation S615 is just an example. In addition, information on time when the session was used may be included in the session identification information.

Operation S630 may be embodied by verifying whether an error occurs when the session key and the session identification information are decrypted using an encryption key used when they were stored.

When a predetermined period of time, e.g., 24 hours, has lapsed since the time of last use of the session key (S615), when no session key and session identification information are present in the session key storage 360 (S625), or when the session key and the session identification information stored in the session key storage 360 have been modulated (S630), the session key generation module 320 of the client generates a new session key in operation S645. In operation S650, the encryption module 340 of the client encrypts the new session key using a server's public key and provides it to the transceiver module 350, and the transceiver module 350 transmits the encrypted new session key to the server.

When a session key resharing request is received from the server in operation S655, operations S645 and S650 are repeated. However, when the session key resharing request is not received from the server, the transceiver module 350 receives a message including a session key and session identification information that have been encrypted using the server's private key from the server in operation S660. In operation S665, the encryption module 340 decrypts the received message using the server's public key, and the storage module 330 stores the decrypted message, i.e., the session key and the session identification information, in the session key storage 360.

FIG. 6B is a flowchart of the operations of a client in another embodiment of the present invention.

Operations S1210 through S1240 shown in FIG. 6B are the same as operations S610 through S640 shown in FIG. 6A, but in the embodiment shown in FIG. 6B, the client generates session identification information. In FIG. 6B, in operation S1245 the client generates a new session key and session identification information. In operation S1250, the client encrypts the new session key and the session identification information using the server's public key and transmits the encrypted new session key and session identification information to the server. When the session key resharing request is received from the server in operation S1255, operations S1245 and S1250 are repeated. However, when the session key resharing request is not received from the server, the client encrypts or decrypts a message using the session key for communication in operation S1240.

FIG. 7A is a flowchart of the operations of a server in an embodiment of the present invention.

In operation S710, the transceiver module 440 receives a session key that has been encrypted using the server's public key from a client. In operation S720, the encryption module 430 decrypts the received session key using the server's private key. In operation S730, the session identification information generation module 405 generates session identification information for management of the session key. In operation S740, the encryption module 430 encrypts the session key and the session identification information using the server's unique key, and the storage module 420 stores the encrypted session key in the session key storage 450. In operation S750, the session key and the session identification information are encrypted using the server's private key and then transmitted to the client. Through the above operations, the server shares the session key with the client. Thereafter, in operation S760, the server decrypts a message received from the client using the session key. When it is determined that an error occurs during the decryption of the message due to a wrong session key in operation S770, the server sends a session key resharing request to the client in operation S780 and repeats operations S710 through S750 to share a session key with the client. However, when the error occurs due to a cause other than the wrong session key, error processing corresponding to the cause, such as sending a message retransmission request to the client, will be performed.

FIG. 7B is a flowchart of the operations of a server in another embodiment of the present invention.

In this embodiment, the session identification information is generated by a client. In operation S1310, the transceiver module 440 of the server receives a session key and session identification information that have been encrypted using the server's public key from the client. In operation S1320, the encryption module 430 decrypts the received session key and session identification information using the server's private key. In operation S1330, the encryption module 430 encrypts the decrypted session key and session identification information using the server's unique key, and the storage module 420 stores the encrypted session key and session identification information in the session key storage 450. In operation S1340, the server decrypts a message received from the client using the session key. When it is determined that an error occurs during the decryption of the message due to the session key in operation S1350, the server sends a session key resharing request to the client in operation S1360 and repeats operations S1310 through S1340.

FIG. 9 illustrates a state in which a plurality of application programs executed on one client share a single session key.

A plurality of web browsers #1 through #n 920 generated on one client, e.g., a personal computer (PC) 910, are provided with services from one server, e.g., a web server 940. Here, if the web browser #1 performs a session key sharing procedure with the web server 940 and, as a result, if a valid session key is stored in a session key storage 930, the other web browsers #2 through #n can use the session key stored in the session key storage 930 without additional session key sharing procedures when communicating with the web server 940.

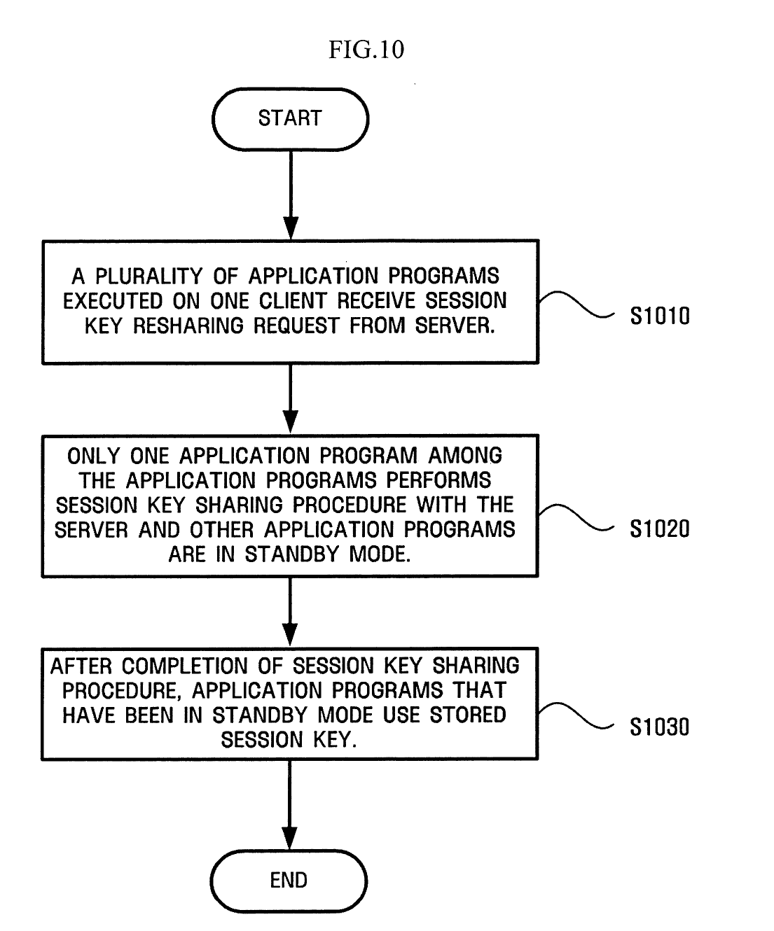

FIG. 10 is a flowchart of operations performed by a client to enable a plurality of application programs executed on the client to share a single session key.

In operation S1010, a plurality of application programs executed on the client receive a session key resharing request from a server. In operation S1020, only one application program among the plurality of application programs receiving the session key resharing request performs the session key sharing procedure with the server and the other application programs are in a standby mode. The application program performing the session key sharing procedure may be an application program that receives the session key resharing request first or may be selected through arbitration between the application programs.

The application program selected using various methods performs the session key sharing procedure with the server. The session key sharing procedure may be embodied by performing operations S645 through S665 shown in FIG. 6A. After the session key sharing procedure is completed, the application programs that have been in the standby mode perform communication with the server according to the method shown in FIG. 6A when they have a message to be transmitted to the server.

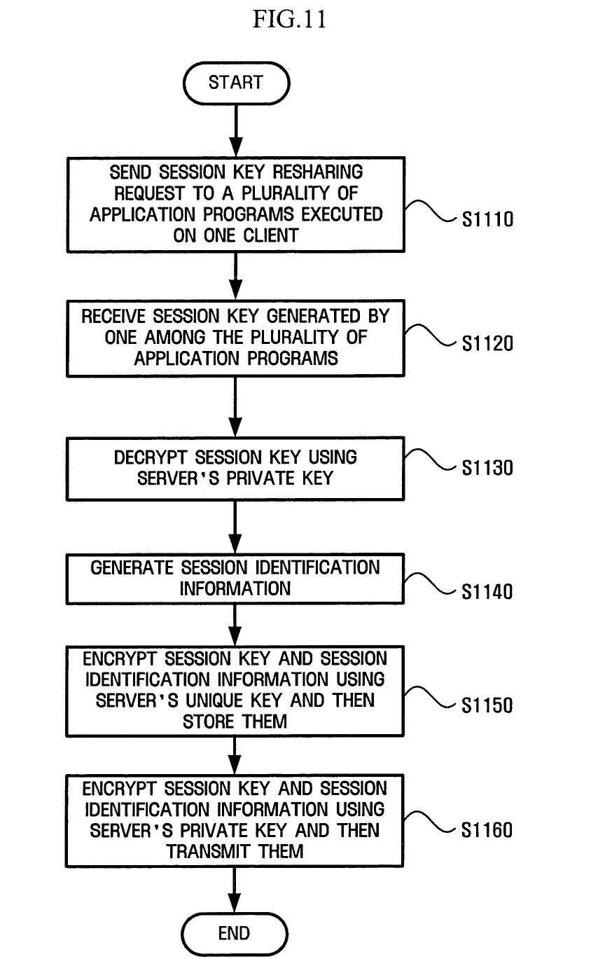

FIG. 11 is a flowchart of operations performed by a server to enable a plurality of application programs executed on one client to share a single session key.

In operation S1110, the server sends a session key resharing request to a plurality of application programs executed on the client. The session key resharing request may be broadcast or multicast. The server performs the session key sharing procedure with one application program among the plurality of application programs. In operation S1120, the transceiver module 440 of the server receives a session key generated by the one application program. In operation S1130, the encryption module 430 of the server decrypts the session key using the server's private key. In operation S1140, the session identification information generation module 405 of the server generates session identification information. In operation S1150, the encryption module 430 encrypts the session key and the session identification information using the server's unique key, and then, the storage module 420 stores the encrypted session key and session identification information in the session key storage 450. In operation S1160, the encryption module 430 encrypts the session key and the session identification information using the server's private key, and the transceiver module 440 transmits the encrypted information to the client.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

A method and apparatus for secure communication according to the present invention may provide at least one among the following effects.

First, even if the connection between a client and a server that have shared a session key is interrupted, the client can use the session key stored therein when accessing the server thereafter without performing an additional session key sharing procedure, thereby reducing a load due to the session key sharing procedure.

Second, since a plurality of application programs generated on one client use the same session key when communicating with a server, the server manages only one session key, and therefore, a load due to session key management can be reduced.

What is claimed is:

1. A method for secure communication between a client and a server, the method comprising:
transmitting a certificate to at least one accessing client;
receiving a session key generated by the client;
generating session identification information corresponding to the session key;
transmitting the session identification information to the client; and
decrypting an encrypted message received from the client using the session key and encrypting a message to be transmitted to the client using the session key.

2. The method of claim 1, wherein the session identification information comprises at least one of identification information of the client and identification information of the server.

3. The method of claim 1, wherein the session key is generated by a predetermined application program executed on the client.

4. The method of claim 3, wherein the session key and the session identification information are shared by a plurality of application programs executed on the client provided with services from the server.

5. A method for secure communication between a client and a server, the method comprising:
transmitting a certificate to at least one accessing client;
receiving a session key and session identification information, which are generated and encrypted using a public key included in the certificate by the client;
decrypting the encrypted session key and session identification information; and
decrypting an encrypted message received from the client, which has transmitted the session identification information, using the session key and encrypting a message to be transmitted to the client, which has transmitted the session identification information, using the session key.

6. The method of claim 5, wherein the session identification information comprises at least one of identification information of the client and identification information of the server.

7. The method of claim 5, wherein the session key is generated by a predetermined application program executed on the client.

8. The method of claim 7, wherein the session key and the session identification information are shared by a plurality of application programs executed on the client provided with services from the server.

9. A method for secure communication between a client and a server, the method comprising:
accessing at least one server;
receiving a certificate from the server;
extracting a public key of the server from the certificate;
generating a session key for communication with the server;
encrypting the session key using the public key and transmitting the encrypted session key to the server;
receiving session identification information corresponding to the session key from the server; and
decrypting an encrypted message received from the server, which has generated the session identification information, using the session key and encrypting a message to be transmitted to the server, which has generated the session identification information, using the session key.

10. The method of claim 9, wherein the session identification information comprises at least one of identification information of the client and identification information of the server.

11. The method of claim 9, wherein the session key is generated by a predetermined application program executed on the client.

12. The method of claim 11, wherein the session key and the session identification information are shared by a plurality of application programs executed on the client provided with services from the server.

13. The method of claim 9, wherein the decrypting of the encrypted message and the encrypting of the message to be transmitted to the server are performed when the session key is valid.

14. The method of claim 13, wherein it is determined whether the session key is valid or not according to at least one of a time lapsed since the session key is used last and a determination result whether the session key has been modulated or not.

15. The method of claim 9, wherein when the session key is not present or when the session key is not valid, the generating of the session key, the encrypting of the session key, the receiving of the session identification information, and the decrypting of the encrypted message are repeatedly performed.

16. A method for secure communication between a client and a server, the method comprising:
accessing at least one server;
receiving a certificate from the server;
extracting a public key of the server from the certificate;
generating a session key and session identification information corresponding to the session key for communication with the server;
encrypting the session key and the session identification information using the public key and transmitting the encrypted session key and session identification information to the server; and
decrypting an encrypted message received from the server, which has been accessed and is identified by the session identification information, using the session key and encrypting a message to be transmitted to the server, which has been accessed and is identified by the session identification information, using the session key.

17. The method of claim 16, wherein the session identification information comprises at least one of identification information of the client and identification information of the server.

18. The method of claim 16, wherein the session key is generated by a predetermined application program executed on the client.

19. The method of claim 18, wherein the session key and the session identification information are shared by a plurality of application programs executed on the client provided with services from the server.

20. The method of claim 16, wherein the decrypting of the encrypted message and the encrypting of the message to be transmitted to the server are performed when the session key is valid.

21. The method of claim 20, wherein it is determined whether the session key is valid or not according to at least one of a time lapsed since the session key is used last and a determination result whether the session key has been modulated or not.

22. The method of claim 16, wherein when the session key is not present or when the session key is not valid, the generating of the session key, the encrypting of the session key, the receiving of the session identification information, and the decrypting of the encrypted message are repeatedly performed.

23. An apparatus for secure communication, comprising:
a session identification information generation module generating session identification information; and
a transceiver module transmitting a certificate to an accessing client, receiving a session key from the client, transmitting the session identification information generated by the session identification information generation module to the client, and transmitting and receiving a message encrypted using the session key.

24. The apparatus of claim 23, wherein the session identification information comprises at least one of identification information of the client and identification information of the server.

25. The method of claim 23, wherein the session key is generated by a predetermined application program executed on the client.

26. The method of claim 25, wherein the session key and the session identification information are shared by a plurality of application programs executed on the client provided with services from the server.

27. An apparatus for secure communication, comprising:
a transceiver module transmitting a certificate to an accessing client, receiving a session key and session identification information from the client, and transmitting and receiving a message encrypted using the session key; and
an encryption module encrypting a message to be transmitted to the client using the session key received by the transceiver module and decrypting an encrypted message received by the transceiver module using the session key.

28. The apparatus of claim 27, wherein the session identification information comprises at least one of identification information of the client and identification information of the server.

29. The apparatus of claim 27, wherein the session key is generated by a predetermined application program executed on the client.

30. The apparatus of claim 29, wherein the session key and the session identification information are shared by a plurality of application programs executed on the client provided with services from the server.

31. An apparatus for secure communication, comprising:
a session key generation module generating a session key;
a transceiver module receiving a certificate from a server, transmitting the session key generated by the session key generation module to the server, receiving session identification information corresponding to the session key from the server, and transmitting and receiving a message encrypted using the session key;
a control module extracting a public key from the certificate received by the transceiver module; and
an encryption module encrypting the session key generated by the session key generation module using the public key extracted by the control module, and encrypting and decrypting a message using the session key.

32. The apparatus of claim 31, wherein the session identification information comprises at least one of identification information of the client and identification information of the server.

33. The apparatus of claim 31, wherein the session key is generated by a predetermined application program executed on the client.

34. The apparatus of claim 33, wherein the session key and the session identification information are shared by a plurality of application programs executed on the client provided with services from the server.

35. An apparatus for secure communication, comprising:
a session key generation module generating a session key;
a session identification information generation module generating session identification information corresponding to the session key;
a transceiver module receiving a certificate from a server and transmitting the session key generated by the session key generation module and the session identification information generated by the session identification information generation module to the server;
a control module extracting a public key from the certificate received by the transceiver module; and
an encryption module encrypting the session key generated by the session key generation module and the session identification information generated by the session identification information generation module using the public key extracted by the control module, and encrypting and decrypting a message using the session key.

36. The apparatus of claim 35, wherein the session identification information comprises at least one of identification information of the client and identification information of the server.

37. The apparatus of claim 35, wherein the session key is generated by a predetermined application program executed on the client.

38. The apparatus of claim 37, wherein the session key and the session identification information are shared by a plurality of application programs executed on the client provided with services from the server.

39. A recording medium having a computer readable program recorded therein, the program for executing the method for secure communication between a client and a server, the method comprising:
transmitting a certificate to at least one accessing client;
receiving a session key generated by the client;
generating session identification information corresponding to the session key;
transmitting the session identification information to the client; and
decrypting an encrypted message received from the client using the session key and encrypting a message to be transmitted to the client using the session key.

40. A recording medium having a computer readable program recorded therein, the program for executing the method for secure communication between a client and a server, the method comprising:
transmitting a certificate to at least one accessing client;
receiving a session key and session identification information, which are generated and encrypted using a public key included in the certificate by the client;
decrypting the encrypted session key and session identification information; and
decrypting an encrypted message received from the client, which has transmitted the session identification information, using the session key and encrypting a message to be transmitted to the client, which has transmitted the session identification information, using the session key.

41. A recording medium having a computer readable program recorded therein, the program for executing the method for secure communication between a client and a server, the method comprising:
accessing at least one server;
receiving a certificate from the server;
extracting a public key of the server from the certificate;
generating a session key for communication with the server;
encrypting the session key using the public key and transmitting the encrypted session key to the server;
receiving session identification information corresponding to the session key from the server; and
decrypting an encrypted message received from the server, which has generated the session identification information, using the session key and encrypting a message to be transmitted to the server, which has generated the session identification information, using the session key.

42. A recording medium having a computer readable program recorded therein, the program for executing the method for secure communication between a client and a server, the method comprising:
accessing at least one server;
receiving a certificate from the server;
extracting a public key of the server from the certificate;
generating a session key and session identification information corresponding to the session key for communication with the server;
encrypting the session key and the session identification information using the public key and transmitting the encrypted session key and session identification information to the server; and
decrypting an encrypted message received from the server, which has been accessed and is identified by the session identification information, using the session key and encrypting a message to be transmitted to the server, which has been accessed and is identified by the session identification information, using the session key.
